(19) United States
(12) Patent Application Publication
(10) Pub. No.: US 2025/0378504 A1
(43) Pub. Date: Dec. 11, 2025

(54) METHOD AND APPARATUS FOR CLASSIFYING A CRYPTOCURRENCY ASSET

(71) Applicant: Laboratory for AI-Powered Financial Technologies Limited, Pak Shek Kok (HK)

(72) Inventors: Xiaofan Liu, Kowloon (HK); Zhenhao Fu, Shanghai (CN); Jiaqi Yan, Nanjing (CN)

(73) Assignee: Laboratory for AI-Powered Financial Technologies Limited, Pak Shek Kok (HK)

(21) Appl. No.: 18/772,118

(22) Filed: Jul. 13, 2024

(30) Foreign Application Priority Data
Jun. 11, 2024 (HK) 32024092521.6

(51) Int. Cl. G06Q 40/12; G06F 16/22; G06Q 30/018

(52) U.S. Cl. CPC G06Q 40/12; G06F 16/2246; G06Q 30/0185

(57) ABSTRACT

A computer-implemented method of classifying a cryptocurrency asset, comprising receiving a plurality of sample transaction records for the asset; generating a spanning tree representing connections between users in the transaction records; calculating a plurality of metrics relating to the generated spanning tree; and using a classification model to analyze the calculated metrics and assign the asset to first classification which indicates the asset is a suspected pyramid scheme or a second classification which indicates the asset is not a suspected pyramid scheme.

### BACKGROUND OF THE DISCLOSURE

### (1) Field of the Invention

The present disclosure relates to the issuance of cryptocurrency assets and, in particular, to the classification of a cryptocurrency asset as a pyramid scheme.

### (2) Description of Related Art

Token and coin issuances, including Initial Coin Offerings (ICOs), serve as a method for raising funds in the cryptocurrency market by selling assets that represent ownership or equity to both individual and institutional investors. Multi-level marketing (MLM), a strategy that involves recruiting members, has frequently been used in fundraising efforts. However, MLMs can quickly turn into pyramid schemes if the assets have no real value and if the issuers intentionally deceive participants.

Current methods for detecting pyramid schemes in asset issuance largely depend on regulatory oversight and manual examinations. For instance, analyzing the text of ICO white papers can reveal possible ill intentions. Additionally, a detailed review of the financial information disclosed by asset issuers, such as how the raised funds are distributed, might uncover irregularities in their financial reports. AI algorithms can be employed to identify unlawful activities using financial data, including the timing of project releases, the total funds collected, and the ethical conduct of the issuers.

Recently, the analysis of blockchain data has provided new methods for identifying illegal activities in asset issuance. For instance, by extracting characteristics from transaction record graphs and applying a lightweight classification model to pinpoint illicit actions, or creating indicators for detecting fraud based on analyzing transaction records and the source code of projects.

However, the effectiveness of financial data-based detection of pyramid schemes is often unsatisfactory. For example, asset issuers can engage in targeted deception by tailoring false information based on the identity of the white paper readers. It can render text mining methods ineffective. Moreover, asset issuers can also falsify financial data in more sophisticated ways to invalidate financial models, thus concealing pyramid schemes.

In addition, current detection methods for illegal activities using blockchain data lack specificity in targeting pyramid schemes. Some research is directed toward identifying Ponzi schemes. However, it is crucial to recognize that pyramid schemes are structured as hierarchical frauds that proliferate through multi-level marketing, whereas Ponzi schemes operate on a flat, sequential basis, making them fundamentally different. Consequently, methods developed to identify Ponzi schemes may not be effective for detecting pyramid schemes.

Finally, there is a lack of differentiation among various types of pyramid schemes in existing research. This absence of detailed discussion on the different models of pyramid schemes hinders a deeper understanding of these scams and the enhancement of monitoring technologies.

It is an object of the present disclosure to address or at least partially ameliorate some of the above problems of the current approaches.

### SUMMARY OF THE DISCLOSURE

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a computer-implemented method of classifying a cryptocurrency asset, comprising receiving a plurality of sample transaction records for the asset; generating a spanning tree representing connections between users in the transaction records; calculating a plurality of metrics relating to the generated spanning tree; and using a classification model to analyse the calculated metrics and assign the asset to first classification which indicates the asset is a suspected pyramid scheme or a second classification which indicates the asset is not a suspected pyramid scheme.

The classification model may be trained by obtaining sample transaction records for a plurality of cryptocurrency assets, where a subset of the cryptocurrency assets are classified as pyramid schemes; generating a spanning tree for each asset; calculating the plurality metrics for each generated spanning tree; and training the classification model using the calculated metrics as input variables and the classification of each asset as a target variable.

The plurality of parameters may include at least one parameter relating to the levels of distribution, at least one parameter relating to the proximity of users in the transaction records, and at least one parameter relating to the expansion rate of a distribution network for the asset.

The first classification may include a first sub-classification which indicates the asset is a real multi-level distribution and a second sub-classification which indicates the asset is a reference and reward scheme.

The classification model may be a logistic regression model, decision tree model, support vector machine or XGBoost model.

The plurality of sample transaction records may be extracted from a blockchain on which the asset operates.

Each sample transaction record may include a source, target, amount and time for an associated transaction.

The sample transaction records may be mapped onto the spanning tree by identifying a plurality of users from the sample transaction records; representing each user as a node of the spanning tree; and mapping connecting edges to represent an aggregated number of transactions between each pair of users over a predefined period of time.

In accordance with a second aspect of the present disclosure, there is provided a computer-readable medium configured to store instructions which, when executed by a processor, cause the processor to perform the method of any preceding claim.

In accordance with a third aspect of the present disclosure, there is provided a data processing apparatus for classifying a cryptocurrency asset, comprising a pre-processor configured to receive a plurality of sample transaction records for the asset and generate a spanning tree representing connections between users in the transaction records; an analytics unit configured to calculate a plurality of metrics relating to the generated spanning tree; and a classification model configured to analyse the calculated metrics and assign the asset to first classification which indicates the asset is a suspected pyramid scheme or a second classification which indicates the asset is not a suspected pyramid scheme.

The classification model may be trained by obtaining sample transaction records for a plurality of cryptocurrency assets, where a subset of the cryptocurrency assets are classified as pyramid schemes; generating a spanning tree for each asset; calculating the plurality metrics for each generated spanning tree; and training the classification model using the calculated metrics as input variables and the classification of each asset as a target variable.

The plurality of parameters may include at least one parameter relating to the levels of distribution, at least one parameter relating to the proximity of users in the transaction records, and at least one parameter relating to the expansion rate of a distribution network for the asset.

The first classification may include a first sub-classification which indicates the asset is a real multi-level distribution and a second sub-classification which indicates the asset is a reference and reward scheme.

The classification model may be a logistic regression model, decision tree model, support vector machine or XGBoost model.

The pre-processor may be configured to extract the plurality of sample transaction records from a blockchain on which the asset operates.

Each sample transaction record may include a source, target, amount and time for an associated transaction.

The pre-processor may be configured to map the sample transaction records onto the spanning tree by identifying a plurality of users from the sample transaction records; representing each user as a node of the spanning tree; and mapping connecting edges to represent an aggregated number of transactions between each pair of users over a predefined period of time.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended Figures. Understanding that these Figures depict only exemplary embodiments of the disclosure and are not therefore to be considered to be limiting of its scope, the principles herein are described and explained with additional specificity and detail through the use of the accompanying Figures.

Preferred embodiments of the present disclosure will be explained in further detail below by way of examples and with reference to the accompanying Figures, in which:

FIG. 1 shows a schematic diagram of a data processing apparatus according to an embodiment;

FIG. 2 shows a schematic representation of a spanning tree;

FIG. 3 shows a further representation of a spanning tree; and

FIG. 4 shows a flowchart of a method of classifying a cryptocurrency asset, according to an embodiment.

### DETAILED DESCRIPTION OF THE EXEMPLARY EMBODIMENTS

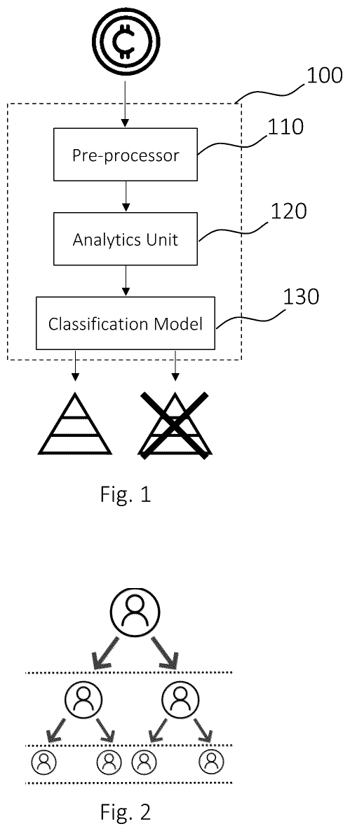

Various embodiments of the disclosure are discussed in detail below. While specific implementations are discussed, it should be understood that this is done for illustration purposes only. A person skilled in the relevant art will recognize that other components and configurations may be used without departing from the scope of the disclosure. Referring to the drawings, FIG. 1 shows a schematic diagram of a data processing apparatus 100 for classifying a cryptocurrency asset according to an embodiment. The asset may be a cryptocurrency coins that operates on its own independent blockchain, or a cryptocurrency token that operates on an existing blockchain network. The data processing apparatus 100 comprises a pre-processor 110, an analytics unit 120, and a classification model 130.

The pre-processor 110 is configured to receive a plurality of sample transaction records for the asset.

The transaction records may be obtained from a primary market of the asset. The primary market, also referred to as an issue market, may represent a space where entities in need of capital issue securities to the general public for an initial time. Analogously, an asset primary market may be seen as a space where cryptocurrency assets may be offered to the public. The inception of such the primary market may be identified when token or coin circulation begins. The primary market may be considered to conclude upon the asset's inaugural pricing appearance on a reputable cryptocurrency data aggregator.

After defining the primary market, primary market transaction records may be retrieved for the asset.

The pre-processor 110 may be configured to extract the plurality of sample transaction records from a blockchain on which the asset operates. For example, tokens on the Ethereum blockchain may be stored within smart contracts, commonly compliant with the ERC-20 standard. Within these contracts, asset ownership may be recorded using a map-like variable consisting of two-tuples: owner, amount.

Each sample transaction record may include a source, target, amount and time for an associated transaction. A transfer function embedded in the smart contract may facilitate a transfer between blockchain addresses. An asset transaction may therefore be written in a four-tuple, i.e., Q={Source, Target, Amount, Time}, where Source may refer to the originating address, Target to the recipient's address, Amount to the transaction volume, and Time to the timestamp of the transaction. The time may be determined by the block height.

The pre-processor 110 is configured to generate a spanning tree representing connections between users in the transaction records. Cryptocurrency asset distribution mechanisms may inherently possess a tree-like structure with the asset issuer at the root and various investor tiers branching out.

FIG. 2 shows a schematic representation of a spanning tree. The top layer may represent an initiator. The middle layer may represent upper/under participants. For example, compared with the nodes in the layers above it, it may be an under participant. Compared with the nodes in the layers under it, it may be an upper participant. The bottom layer may represent under participants.

The pre-processor 110 may be configured to map the sample transaction records onto the spanning tree by identifying a plurality of users from the sample transaction records; representing each user as a node of the spanning tree; and mapping connecting edges to represent an aggregated number of transactions between each pair of users over a predefined period of time.

In this way, asset transactions in the primary market may be represented as a weighted, directed transaction network, given by G={V,E}, where V and E may be the node and edge sets respectively. The edges connecting nodes may encapsulate the AggAmount, representing the cumulative transaction amount during the primary market phase. This may be articulated as ei={Source, Target, AggAmount}.

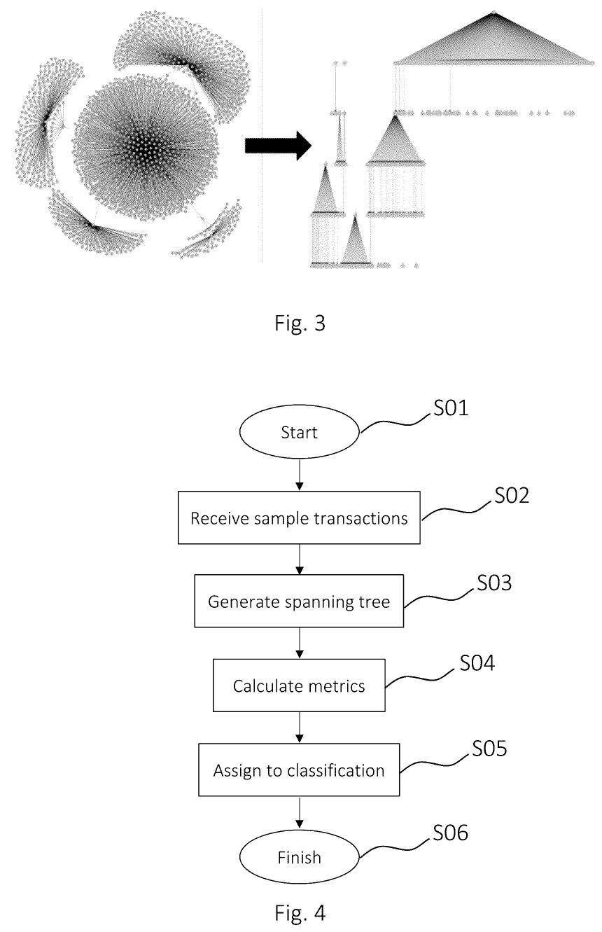

FIG. 3 shows a further representation of an asset distribution network juxtaposed with a corresponding Directed Maximum Arborescence (DMA) spanning tree. The spanning tree may be generated by deriving the DMA from primary market asset transaction networks. DMA may be used to generate a spanning tree originating from the issuance initiator, with all nodes reachable and optimizing for the maximum edge weight.

The analytics unit 120 is configured to calculate a plurality of metrics relating to the generated spanning tree.

The classification model 130 is configured to analyse the calculated metrics and assign the asset to first classification which indicates the asset is a suspected pyramid scheme or a second classification which indicates the asset is not a suspected pyramid scheme.

In this way, the data processing apparatus 100 provides a novel data structure for representing asset distribution, enhancing the analysis of transaction records. This can address the lack of a structured method for analysing and categorizing asset distribution.

In this way, the data processing apparatus 100 can precisely identify pyramid schemes as a hierarchical, multi-level business model in which participants receive commissions for recruiting new members into the structure. The data processing apparatus 100 can differentiate a pyramid scheme from the linear progression typical of a Ponzi scheme.

The data processing apparatus 100 can distinguish pyramid schemes within the context of token or coin issuance by leveraging blockchain data analytics. Pyramid schemes may be categorised based on the unique characteristics of their token distribution mechanisms, enabling a real-time, efficient, and cost-effective approach to identify these pyramid schemes using data derived from the blockchain. This can not only enhance the precision of detection but also contribute to a more nuanced understanding of pyramid schemes in the digital currency domain.

Utilizing transaction record analysis technology, the data processing apparatus 100 can analyse participant behaviour in asset issuances through the spanning tree and its associated metrics. This approach can allow for the continuous updating of evaluations regarding the presence of pyramid schemes as new transaction records emerge. This real-time detection capability can be critical for timely intervention and the prevention of fraud, offering a proactive rather than reactive approach to identifying and mitigating pyramid schemes in the blockchain ecosystem.

By offering a systematic and objective method to analysing asset distribution patterns, the data processing apparatus 100 can enhance market transparency, mitigate investment risks, and support the development of a healthier, more secure blockchain industry. This contributes to the overall growth and sustainability of the cryptocurrency market, encouraging broader adoption and innovation.

The classification model 130 may be a logistic regression model, decision tree model, support vector machine or XGBoost model. Such machine learning algorithms may be configured to learn from identified patterns of pyramid schemes and improve detection over time. These models may be configured to adapt to new schemes as they evolve.

The classification model 130 may be trained by obtaining sample transaction records for a plurality of cryptocurrency assets, where a subset of the cryptocurrency assets are classified as pyramid schemes.

In an example implementation, between 1 Dec. 2016 and 31 Dec. 2021 a collection of 43 token issuances, either convicted or widely acknowledged as pyramid schemes, were manually curated. The data were primarily sourced from the U.S. Securities and Exchange Commission's Cyber Enforcement Actions section (SEC, 2017), supplemented with information from online sources. Of these 43 token issuances, 18 were operationalized on the Ethereum platform.

To distinguish differences between pyramid scheme asset issuances and their legitimate counterparts, a control group and a treated group may be created for subsequent comparative analysis. In the example, the treated group comprised 18 pyramid scheme token issuances launched on Ethereum. Asset issuances below a threshold volume may be excluded. For example, issuances with fewer than 100 addresses engaged in asset transactions. In the example, this exclusion resulted in a refined set of 15 pyramid scheme token issuances for the treated group.

The control group may be assembled according to certain criteria. For example, legitimate asset issuances may be required to have a participant count surpassing 100. A predefined number of three legitimate asset issuances may be identified for each pyramid scheme asset issuance. For example, three legitimate asset issuances may be identified for each pyramid scheme asset issuance. Both legitimate and pyramid scheme token issuances may be required to have been issued within the same year and quarter. The difference in primary market duration between the two token issuance categories may be limited to a 20-day or 40-day window. The time frame may be extended to include adjacent quarters under certain conditions e.g. if no matching legitimate token issuances met the earlier conditions.

In the example, a dataset was constructed consisting of transaction records for 60 token issuances, including 15 pyramid scheme token issuances and 45 legitimate counterparts. These transaction records totalled 1,523,214 entries, involving 493,594 unique addresses in the transaction record graphs.

The classification model 130 may be trained by generating a spanning tree for each asset. As described above, DMA may be utilised to simplify the transaction records and form spanning trees. In the example implementation, 60 token issuances resulted in 60 different token distribution spanning trees, reducing the number of transaction records from 1,523,214 to 746,461 and the unique address count from 493,594 to 361,872. Exchange addresses may be removed from the spanning trees. In the example, examining exchange addresses within the token distribution spanning trees and pruning them reduced the number of transaction records to 613,219 and the address count to 296,732.

The classification model 130 may be trained by calculating the plurality metrics for each generated spanning tree. To prepare the data for the machine learning model, further data pre-processing may be conducted. For example, the growth metrics may be transformed into scalars by taking the variance. Normalization may be applied to all metric results. The SMOTE method may be used to address the issue of imbalanced samples.

The classification model 130 may be trained by training the classification model 130 using the calculated metrics as input variables and the classification of each asset as a target variable.

In the example implementation, the ratio of pyramid scheme token issuances to legitimate token issuances in the data set is 1:3, so the probability of finding a pyramid scheme by random guessing is 25%. Using this as a baseline, an XGBoost model's F1 score is 80.4%, Recall is 82.2%, Precision is 78.7%, and Accuracy is 80%, which is a substantial improvement.

The plurality of parameters may include at least one parameter relating to the levels of distribution, or “Hierarchy”. At least one parameter may relate to the proximity of users in the transaction records, or “Closeness”. At least one parameter may relate to the expansion rate of a distribution network for the asset, or “Growth”. The analytics unit 120 may calculate between 10 and 20 different metrics. For example, the analytics unit 120 may calculate any or all of the 13 metrics listed below. In this way, the analytics unit 120 can provide a thorough assessment of token issuing characteristics, and can resolve the absence of a standardized evaluation system for distinguishing pyramid schemes from legitimate token issuing.

Hierarchy MLM and pyramid schemes may recruit members in a snowballing fashion, therefore forming a multilayer hierarchy among members, resembling a pyramid shape. On the contrary, crowdfunding or single-layer broking may form shorter trees. The following six metrics may characterize the hierarchy structure of the spanning tree.

Maximum Depth of Distribution (MDD) may describe the maximum number of steps required to access all other nodes from the root node of the token distribution tree. A larger MDD may indicate a greater number of levels in the tree, indicating a more pronounced hierarchical structure.

Average Depth of Distribution (ADD) may characterize the distance and interconnectedness between participants at different levels within a distribution network. It may be defined as the average distance from the root node to all leaf nodes in the token distribution tree. A larger ADD may indicate a more pronounced multi-level marketing pattern.

From the perspective of a transaction network structure, it may be observed that networks with a larger number of nodes tend to exhibit a greater MDD. The Balanced Depth of Distribution (BDD) may be configured to mitigate the impact of node count discrepancies on the accuracy of the MDD. The specific calculation formula for BDD may be as follows:

$$Balanced Depth of Distribution = \frac{Maximum Depth of Distribution}{Number of Nodes}$$

Distribution intensity (DI) may depict the turnover rate of tokens between different levels in a distribution tree. Letting SWᵢ (Sum of Weight) denote the total amount of tokens distributed from nodes in one layer to nodes in the next layer, the distribution intensity may be calculated as follows:

$$DI = \frac{{\sum }_{i = 2}^{n - 1} s {w}_{i}}{s {w}_{1}}$$

Where n may represent the total number of layers in the token distribution tree. Therefore, a higher distribution intensity may indicate a larger volume of tokens issued by the issuer circulating and being exchanged, reflecting a more active token distribution activity.

In the token distribution tree, the number of downline nodes developed by an upline node may be regarded as the distribution capacity of the upline node. When an upline node develops more than one downline node, we may consider it an effective distribution node. The ratio of effective nodes to the total number of nodes may referred to as the Distribution Node Ratio (DNR). Pyramid scheme issuances may be assumed to have a higher DNR compared to legitimate issuances.

Structural Virality (SV) may be used to evaluate the potential and speed of information or phenomena spreading in a network by analysing its structure. It may be used to assess the effectiveness of advertising and promotional campaigns on social media. A higher SV may indicate that information or phenomena can spread faster, reach a wider audience, and have a greater impact within the social network. The calculation formula for SV may be as follows:

$$SV = \frac{Wiener\_Index ( T )}{NON \times ( NON - 1 )}$$

Where Wiener_Index (T) may calculate the Wiener index of a specific token distribution tree, and NON may represent the total number of nodes in the token distribution tree. By referencing and utilizing this metric, we may assess the formation and propagation speed of different levels within a token distribution tree.

Closedness may be considered another important characteristic for assessing multi-level marketing. Unlike conventional business marketing, the commercial activities within such networks may be primarily confined to the network itself and may have limited openness to the external world. This may result in a higher degree of closure, making it difficult for external nodes to join and creating denser connections among internal nodes.

Numbers of Nodes (NON) in the token distribution tree may represent the quantity of investors participating in the multi-level marketing plan. This metric may provide a straightforward indication of the number of investors involved in a specific project and the size of the network presented.

Average In-Degree (AID) may refer to the average number of incoming edges for all non-root nodes in a token distribution tree. A higher AID may indicate that investors obtain tokens more frequently from the token issuer and upline nodes, implying a greater number of token acquisitions and additional investments by investors.

Denoting the total number of nodes in the token distribution tree as NON, the number of nodes located at layer i may be noni, and there may be n layers. The node distribution may be constructed from the first level of the distribution tree to the last level as Q={non₁, non₂, . . . , nonₙ}. Maximum Width of Distribution (MWD) may be calculated as follows:

$$MWD = max ( \{ \frac{{non}_{1}}{NON} , \frac{{non}_{2}}{NON} , … , \frac{{non}_{n}}{NON} \} )$$

For a token distribution tree, MWD may accurately represent the maximum concentration level of nodes at a particular layer. A higher MWD may indicate that investors have a closer relationship with the token issuer rather than their own upline nodes.

Out-Degree Ratio (ODR) may be defined as the maximum out-degree in a token distribution tree divided by the out-degree of all nodes. It may reflect the engagement level of the node with the highest out-degree in initiating transactions compared to all nodes. A higher ODR may indicate a higher level of transaction engagement initiated by important nodes.

In-Degree Ratio (IDR), corresponding to the Out-Degree Ratio, may reflect the engagement level of the node with the highest in-degree in receiving transactions compared to all nodes. A higher IDR may indicate a higher level of engagement in terms of receiving token transactions by important nodes.

Growth may be the third significant characteristic used to assess multi-level marketing. Different types of networks may exhibit variations in their growth curves and cycles, which may serve as important metrics for identifying network attributes.

The node distribution Q={non₁, non₂, . . . , nonₙ} may be manipulated to obtain a sequence of Node Distribution Rate (NDR), denoted as P:

$$P = \{ \frac{{non}_{1}}{NON} , \frac{{non}_{2}}{NON} , … , \frac{{non}_{n}}{NON} \}$$

Token Distribution Rate (TDR) may portray the ratio of the number of tokens distributed by each layer of the participants to the number of tokens issued. It may be a sequence as follows:

$$\{ \frac{{SW}_{1}}{{SW}_{1}} , \frac{{SW}_{2}}{{SW}_{1}} , … , \frac{{SW}_{n - 1}}{{SW}_{1}} \}$$

Where n may be the maximum number of layers, and SW may be as defined in the distribution intensity. The token distribution rate may reveal the turnover rate of tokens among different levels, showing the changes in market trading activity for tokens from the beginning of their issuance.

The first classification may include a first sub-classification which indicates the asset is a real multi-level distribution and a second sub-classification which indicates the asset is a reference and reward scheme.

In the real multi-level distribution model, participants may acquire assets from a preceding tier. Subsequently, they may onboard additional participants, thus bolstering the asset's value before ultimately liquidating their tokens at a premium. There may be a direct correlation observed between the influx of new participants and the appreciation of the asset's price. This correlation may facilitate the engagement of a broader participant base, further augmenting the asset's valuation. Such a dynamic may encourage an expanded group of participants to invest in assets at inflated prices with the expectation of returns. Nonetheless, as the resale value of the token approaches its peak, the model may face challenges in participant recruitment and diminishing returns.

In contrast, the reference and reward model may operate base on the attraction of new affiliates through a referral mechanism. Incentives in the form of asset bonuses may be provided to established participants who introduce newer participants through the referral system. Notably, in this paradigm, assets may not pass through the senior participant. Instead, new recruits may utilize a referral code during their purchase. Asset issuers may promise a commission to the owner of the referral code and usually the owner's referrer. These referral transactions often may not be recorded, as the referral codes may be processed outside the blockchain infrastructure.

By clearly distinguishing between real multi-level distribution and reference and reward models of pyramid schemes, the data processing apparatus 100 can offer a refined understanding of fraudulent practices in token issuance. This distinction can enable the identification of deceptive schemes with a level of insight and specificity not achievable with previous approaches. Such precise definitions can help in tailoring detection mechanisms to the nuanced differences between types of pyramid schemes, thereby improving the accuracy of fraud detection.

In training, the 18 pyramid scheme token issuances collected may be analysed to categorise these pyramid scheme token issuances as real multi-level distribution and reference and reward models of pyramid schemes. For example, analysis of the whitepapers and/or regulatory judgments associated with the pyramid scheme token issuances may identify the category.

In the example, the data processing apparatus 100 can perform well in distinguishing between the two pyramid schemes, with an F1 score of 83.4%, Recall of 83.7%, Precision of 83.4%, and Accuracy of 83.7%.

By leveraging the continuous stream of transaction data on the blockchain, the data processing apparatus 100 can update its analysis in real-time as new transactions occur. This can enable immediate detection of potential pyramid schemes, offering a dynamic and proactive fraud detection mechanism.

FIG. 4 shows a flowchart of a method of classifying a cryptocurrency asset, according to an embodiment. The method starts at step S01.

At step S02, a plurality of sample transaction records are received for the asset.

At step S03, a spanning tree is generated representing connections between users in the transaction records.

At step S04, a plurality of metrics are calculated relating to the generated spanning tree.

At step S05, a classification model is used to analyse the calculated metrics and assign the asset to first classification which indicates the asset is a suspected pyramid scheme or a second classification which indicates the asset is not a suspected pyramid scheme.

The method finishes at step S06.

The above embodiments are described by way of example only. Many variations are possible without departing from the scope of the disclosure as defined in the appended claims.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method of classifying a cryptocurrency asset, comprising:
receiving a plurality of sample transaction records for the asset;
generating a spanning tree representing connections between users in the transaction records;
calculating a plurality of metrics relating to the generated spanning tree; and
using a classification model to analyze the calculated metrics and assign the asset to first classification which indicates the asset is a suspected pyramid scheme or a second classification which indicates the asset is not a suspected pyramid scheme.

2. The computer-implemented method of claim 1, wherein the classification model is trained by:
obtaining sample transaction records for a plurality of cryptocurrency assets, where a subset of the cryptocurrency assets are classified as pyramid schemes;
generating a spanning tree for each asset;
calculating the plurality metrics for each generated spanning tree; and
training the classification model using the calculated metrics as input variables and the classification of each asset as a target variable.

3. The computer-implemented method of claim 1, wherein the plurality of parameters includes at least one parameter relating to the levels of distribution, at least one parameter relating to the proximity of users in the transaction records, and at least one parameter relating to the expansion rate of a distribution network for the asset.

4. The computer-implemented method of claim 1, wherein the first classification includes a first sub-classification which indicates the asset is a real multi-level distribution and a second sub-classification which indicates the asset is a reference and reward scheme.

5. The computer-implemented method of claim 1, wherein the classification model is a logistic regression model, decision tree model, support vector machine or XGBoost model.

6. The computer-implemented method of claim 1, wherein the plurality of sample transaction records are extracted from a blockchain on which the asset operates.

7. The computer-implemented method of claim 1, wherein each sample transaction record includes a source, target, amount and time for an associated transaction.

8. The computer-implemented method of claim 1, wherein the sample transaction records are mapped onto the spanning tree by:
identifying a plurality of users from the sample transaction records;
representing each user as a node of the spanning tree; and
mapping connecting edges to represent an aggregated number of transactions between each pair of users over a predefined period of time.

9. A computer-readable medium configured to store instructions which, when executed by a processor, cause the processor to perform the method of claim 1.

10. A data processing apparatus for classifying a cryptocurrency asset, comprising:
a pre-processor configured to receive a plurality of sample transaction records for the asset and generate a spanning tree representing connections between users in the transaction records;
an analytics unit configured to calculate a plurality of metrics relating to the generated spanning tree; and
a classification model configured to analyze the calculated metrics and assign the asset to first classification which indicates the asset is a suspected pyramid scheme or a second classification which indicates the asset is not a suspected pyramid scheme.

11. The data processing apparatus of claim 10, wherein the classification model is trained by:
obtaining sample transaction records for a plurality of cryptocurrency assets, where a subset of the cryptocurrency assets are classified as pyramid schemes;
generating a spanning tree for each asset;
calculating the plurality metrics for each generated spanning tree; and
training the classification model using the calculated metrics as input variables and the classification of each asset as a target variable.

12. The data processing apparatus of claim 10, wherein the plurality of parameters includes at least one parameter relating to the levels of distribution, at least one parameter relating to the proximity of users in the transaction records, and at least one parameter relating to the expansion rate of a distribution network for the asset.

13. The data processing apparatus of claim 10, wherein the first classification includes a first sub-classification which indicates the asset is a real multi-level distribution and a second sub-classification which indicates the asset is a reference and reward scheme.

14. The data processing apparatus of claim 10, wherein the classification model is a logistic regression model, decision tree model, support vector machine or XGBoost model.

15. The data processing apparatus of claim 10, the pre-processor is configured to extract the plurality of sample transaction records from a blockchain on which the asset operates.

16. The data processing apparatus of claim 10, wherein each sample transaction record includes a source, target, amount and time for an associated transaction.

17. The data processing apparatus of claim 10, wherein the pre-processor is configured to map the sample transaction records onto the spanning tree by:
identifying a plurality of users from the sample transaction records;
representing each user as a node of the spanning tree; and
mapping connecting edges to represent an aggregated number of transactions between each pair of users over a predefined period of time.
